(19) United States
(12) Patent Application Publication
(10) Pub. No.: US 2018/0363985 A1
(43) Pub. Date: Dec. 20, 2018

(54) Grate Plate for a Grate Cooler

(71) Applicant: KHD HUMBOLDT WEDAG GMBH, Koeln (DE)

(72) Inventors: Waldemar KOROTEZKY, Euskirchen (DE); Klaus ZENKER, Bergisch Gladbach (DE); Ravi SAKSENA, Koeln (DE)

(21) Appl. No.: 15/778,700

(22) PCT Filed: Nov. 24, 2016
(86) PCT No.: PCT/EP2016/078659

§ 371 Date: May 24, 2018

(30) Foreign Application Priority Data
Dec. 3, 2015 (DE) 10 2015 015 632.2

(51) Int. Cl. F27D 15/02

(52) U.S. Cl. CPC F27D 15/022; F27D 2015/0233

(57) ABSTRACT

A grate plate used in a grate cooler for bulk material, comprising a first region alternately covered by a further grate plate during use and having at least one pocket for holding bulk material as an autogenous wear protection layer, and a second region not covered during use, and also having at least one bulk material pocket and at least one cooling air opening leading to a grate plate underside. The height of the first region pockets is smaller than the second region pockets height. The base of the first region pockets is formed by multiple segments having upper surfaces as bulk material contact surfaces and between which gap-like cooling air channels are formed. Openings of the cooling air channels are oriented at an angle to vertical, such that an acute angle occurs between the conveying direction and the direction of the cooling air flow via these openings.

### CROSS-REFERENCES TO RELATED APPLICATIONS

This application claims the benefit of the German patent application No. 10 2015 015 632.2 filed on Dec. 3, 2015, the entire disclosures of which are incorporated herein by way of reference.

### BACKGROUND OF THE INVENTION

The invention relates to a grate plate for use in a grate cooler for hot bulk material having a first operating region (“covering region”) which is alternately covered by at least one additional grate plate when the grate plate is used in a grate cooler, wherein the covering region has at least one pocket for retaining bulk material as an autogenous wear protection layer, and a second operating region (“non-covering region”) which is not covered by an additional grate plate when the grate plate is used on a grate cooler, wherein the non-covering region for retaining bulk material as an autogenous wear protection layer has at least one pocket having at least one opening which leads to the lower side of the grate plate for the introduction of cooling air.

Grate coolers are used to cool hot bulk material, such as, for example, burnt mineral material or cement clinker which is discharged from a rotary tubular kiln. The hot bulk material is in this instance transported over the cooling path of the grate cooler and typically cooled by means of heat exchange with cooling air which is introduced with a transverse flow method. A transport method which is also suitable under extreme temperature and abrasive wear conditions is based on the widely used push grate cooler system. The grate cooler comprises in this instance grate plate carriers which are arranged one behind the other in steps. In this instance, static grate plate carriers which are fixed in the transport direction alternate with movable grate plate carriers which move in a manner supported on movable driven push frames in the transport direction and back again counter to the transport direction. As a result of this oscillating movement, the bulk material is pushed over the steps and conveyed through the cooler. Transversely relative to the transport, that is to say, conveying direction, grate plates are arranged in rows beside each other in the grate plate carriers. The operating region of the grate plates is intended to be understood to be the surface portion of the upper side thereof on which the hot bulk material rests or via which during the conveying process the bulk material is moved. In an alternating manner, as a result of the back and forth movement of the movable grate plate carrier, there is produced a partial overlapping or covering of two (rows of) grate plates which successively follow each other in a stepped manner Accordingly, the operating region of each grate plate is divided (apart from on the first, uppermost step) into two operating regions, that is to say, into a first operating region which during operation of the grate cooler as a result of the oscillating conveying movement of the movable steps is alternately covered by at least one grate plate of the step located above, in short: “covering region,” and in a second operating region which is not covered by any grate plate of the step located above, that is to say, a non-covering region.

The grate plates are in particular subjected to two powerful and also cooperating wear effects. On the one hand, the high temperature of the hot bulk material which is frequently over 1000° C. softens the grate plate material, in most cases steel. On the other hand, the grate plate is attacked by means of abrasive wear at the upper side thereof as a result of the relative movement in relation to the hot bulk material which is often present as granules. In order to protect from such thermo-mechanical overloads, grate plates therefore often have trough-like or pocket-like recesses. In the previously filed patent application with the file reference 10 2014 008 010.2 there are proposed grate plates whose operating region has such pockets both in the covering region and in the non-covering region. In the, for example, parallelepipedal pockets of a grate plate, as a result of the recess provided in the vertical extension direction, that is to say, the height thereof, a portion of the bulk material is retained. This material which is retained acts, on the one hand, as an autogenous wear protection layer since it prevents direct contact of the material which is transported via the plate with the pocket base. On the other hand, this cooling layer also acts as thermal insulation so that the grate plates at least in the region of the pockets as a result of the lower temperature have a higher surface hardness and consequently also a higher resistance against wear.

It is further known to blow cooling air into the pockets through openings in the base of the grate plates. The cooling air then flows through the transported hot bulk material layer and, with the temperature of the cooling air being increased, stores heat which can potentially be used again at another location of the overall process, that is to say, can be recovered, as is the case with cement production. The physically technical implementation of the throughflow of the conveyed hot bulk material layer and the region of the autogenous wear protection layer which is formed is decisive for the effectiveness and uniformity of the cooling operation and the service-life of the grate plates and consequently of the grate cooler.

With the grate plate disclosed in the patent application set out (file reference 10 2014 008 010.2), there are achieved as a result of the pocket arrangement/nature (which is largely indiscriminate over the entire operating region) and as a result of the introduction of cooling air thereof by means of an opening at the lower side of the grate plate, a lowering of the air resistance caused by the air supply and bulk material, which results in high energy costs for producing the cooling air flow (compressor power), furthermore a homogenization of the overall air resistance, whose fluctuations as a result of control mechanisms in the cooling air supply (controlled compressor) have to be compensated for, and a reduction of the wear by also forming an autogenous wear protection layer in the covering region.

However, an objective still remains to further improve the cooling and wear protection. In this instance, it should be noted that, with an identical pocket configuration in the covering region and in the non-covering region, precisely in the covering region as a result of the oscillating back and forth pushing movement over the pockets, an increasing and considerable compression of the bulk material layer in the pockets disadvantageously occurs (in comparison with the compression in the pockets of the non-covering region). This leads in this instance to a considerable increase of the flow resistance or to a significant pressure loss in the cooling air flow which with the compensation thereof is not only cost-intensive but also with an overall air supply to the grate cooler or to the respective grate plates in the non-covering, less highly compressed region, disadvantageously leads to a formation of (vertical) temperature gradients in the bulk material bed, which lead to a poor effective and uniform cooling of the conveyed bulk material. Furthermore, with such a necessary increase of the air flow speed in the supply region there is disadvantageously an increasing risk of spaces or cold channel formations. Furthermore, also in a disadvantageous manner, on the pocket base in the covering region the wear which is increased by the compression of the bulk material layer and which is in particular caused by temperature cannot generally already be sufficiently reduced by cooling by means of cooling air supply through conventional openings which lead to the lower side of the grate plate.

### SUMMARY OF THE INVENTION

An object of the invention is therefore to provide a grate plate for use in a grate cooler for hot bulk material which overcomes or at least reduces the disadvantages set out in the prior art in relation to cooling properties, efficiency and wear.

According to the invention, therefore, there is provision for the height of the at least one pocket in the covering region to be smaller than the height of the at least one pocket in the non-covering region. With pockets whose bases in a non-typical case are not produced in a planar and horizontal manner, the mean height has to be taken as a basis in this instance. With a plurality of pockets on the grate plate which have different heights which are, for example, adapted to the bulk geometry which is typical in each case during operation of the grate cooler, consequently, the deepest pocket, that is to say, the pocket of the covering region with the greatest height dimension, is smaller than the pocket with the smallest height of the non-covering region. The person skilled in the art will firstly select the height of the pockets in the covering region in an optimizing manner so that, on the one hand, a sufficient autogenous wear protection layer is constructed therein but which, on the other hand, does not have an excessively great layer thickness which would unnecessarily increase the flow resistance or the pressure drop. Based on this, configuring the height of the pockets in the covering region according to the invention to be smaller, typically considerably smaller, but without constructing the pockets in such a flat manner that no wear protection layer could be maintained, leads to the described compression of the maintained bulk material layer being less significant. The flow resistance or pressure loss in the covering region is therefore with respect to the use of pockets with the same height as in the non-covering region advantageously reduced so that the disadvantages explained in the introduction—in particular with regard to an uneconomical increase of the air flow speed, with regard to temperature-related wear in the pockets of the covering region and with regard to cooling disadvantages in the non-covering region (unfavorable temperature gradients, cooling channel risk)—are combatted.

In favor of an advantageous construction type which is as simple as possible, in a preferred embodiment the pockets are configured in such a manner that the pockets in the covering region have the same height with respect to each other and the pockets in the non-covering region have the same height with respect to each other. Furthermore, there is provision for the height of the at least one pocket in the covering region to be smaller than a third, preferably smaller than a fifth, of the height of the at least one pocket in the non-covering region. In this instance, with respect to the lower limit (smallest height) provision should be made for the possible construction of an autogenous wear protection layer. This is dependent on the nature of the hot bulk material, but it has been found that the retention of such a layer for typical grate cooler applications, in particular with cement clinker cooling, is also readily possible with heights of the mentioned height relationships. In some such applications, the height of the pocket in the covering region should typically not be less than 5% of the pocket height of the non-covering region. Surprisingly, it has further been found that, with such a reduction of the pocket height (to less than a third, preferably less than a fifth) with respect to the pocket height of the non-covering region, a good wear protection of the pockets in the covering region and an effective uniform cooling in the overall region are ensured, which can be attributed to the alternating freeing of the covering region from a hot material bed layer as a result of the oscillating travel movement.

According to the invention, there is further provision for the base of the at least one pocket in the covering region to be formed by a plurality of segments whose upper sides act as a support face for bulk material and between which gap-like cooling air channels are formed for the supply of cooling air. In this instance, when the grate plate is used in a grate cooler, the openings of the cooling air channels which are produced between the upper sides of the segments are each orientated at such an angle with respect to the vertical that there is an acute angle between the conveying direction of the bulk material and the direction of the cooling air flow through the openings. A type of flow of the bulk material formed in this manner, which flow, apart from occurrences of redirection and turbulence on and in the bulk material, is orientated with a vectorial component primarily in the conveying direction, additionally supplies the surface of the grate plate on the pocket base, consequently the upper segment sides, in comparison with openings which are directed precisely in an upward direction with cooling air and in this manner additionally reduces the temperature-related wear of the grate plate.

In a preferred embodiment of the invention, there is provision for the openings of the cooling air channels produced between the upper sides of the segments in the covering region to be orientated in such a manner that, when the grate plate is used in a grate cooler, the cooling air flow is introduced substantially in the conveying direction of the bulk material. Consequently, the cooling air flow during introduction is directed substantially parallel with the surface of the segments which both reduces the compression effect if not completely preventing it according to the invention (a sufficient autogenous wear protection layer is maintained) and ensures better cooling of the segments, consequently of the pocket. Small—included by the term “approximate”—deviations with respect to the precise conveying direction or surface orientation are in practice naturally produced by the physical properties of the cooling air flow, for example, local redirections and small turbulences at edges or also as a result of potentially not totally even and/or horizontal segment surfaces, but do not impair the advantageous effect in a sustained manner After the introduction of the cooling air flow in this direction, there are redirections of the cooling air on the particles of the wear protection layer and, in the corresponding phase of the pushing cycle, on the particles of the conveyed bulk material bed.

Typically, there are functionally advantageously arranged in a grate cooler for each plurality of grate plates in a row beside each other, that is to say, transversely relative to the conveying direction, and in a grate plate the pockets themselves in rows transversely and parallel relative to the conveying direction, that is to say, in a mesh-like or grid-like manner. With regard to the arrangement of the segments which form the base of the pockets in the covering region, an advantageous embodiment of the invention makes provision in the at least one pocket in the covering region for the segments which form the base to be arranged one behind the other with respect to the conveying direction. As a result of the openings of the cooling air channels which are formed in this instance in a gap-like manner between adjacent segments in an uninterrupted manner over the entire pocket width, a uniform cooling is promoted. Linear segment borders which are formed in this instance perpendicularly to the conveying direction have been found to be particularly advantageous in this instance.

In order to be able to connect the grate plate when it is used with the grate cooler, for instance, to the frame construction or the drive rod assembly thereof, in a durable but releasable manner, there is provision in an advantageous embodiment of the invention at the lower side of the grate plate below the covering region for a connection element, for example, a hook device, to be provided for securing the grate plate in a grate cooler. For reasons of symmetrical force loading, such a hook or a correspondingly different connection element is preferably intended to be arranged at the center of the lower side, that is to say, in the vertical center plane of the grate plate which extends parallel with the conveying direction. Below the covering region, as a result of the operating method of the grate cooler, there is again no overlapping with an additional grate plate located below this plate; instead there is at that location a free space which can be used for said securing. For stable securing, it may be found to be advantageous to provide no pockets in the central region of the covering region. In this instance, however, sufficient cooling of this pocket-free central region of the covering region should be ensured, for example, by directing the cooling air flow of the adjacent pockets toward the central region.

The segments form according to the invention with the upper sides thereof the support faces for the bulk material which acts as a wear protection layer in the pockets of the covering region and consequently the base of these pockets. The upper sides are therefore, for example, constructed in a substantially planar manner Furthermore, the segments have to be able to withstand the force loads as a result of the hot bulk material thereon which is conveyed with pushing pressure and in each case to form between them the cooling air channels according to the invention. Furthermore, there is the not least economically relevant condition that the segments can be produced in a simple manner. As has been shown, these requirements are met in the preferred embodiment of the invention in which the segments of the at least one pocket in the covering region in vertical cross-section parallel with the conveying direction have a substantially dual-angled profile. From a longitudinal side of the plate (which is in this instance assumed to be supported horizontally), when viewed transversely relative to the conveying direction, the segments therefore have a dual-angled profile with at the bottom a horizontal flat substantially parallelepipedal component, an upwardly extending component which adjoins the end thereof (when viewed in the conveying direction) and which is also substantially parallelepipedal, and with a third substantially horizontal, substantially parallelepipedal component which begins at the end thereof and which forms the upper side of the segment in the conveying direction so that in profile the shape of a stylized, angular “S” is produced. However, the shape, as the term “substantially” is intended to indicate is not determined at precisely perpendicular internal angles between the components, but instead the shape may also be slightly cropped, preferably cropped in the conveying direction. Furthermore, the edges between the components may also be rounded for production reasons; slightly bent components also comply with the requirements which are mentioned. In order to enable the discharge of the cooling air according to the invention from the cooling air channels between the segments at an angle with respect to the vertical, in a borderline case even directly in the conveying direction or parallel with the upper sides of the segments, the double-angled segments can preferably be constructed with a cropped form in the transport direction and/or be arranged with the upper sides thereof (descending in the transport direction) in a stepped manner or also be constructed with correspondingly oblique or chamfered upper sides.

Another advantageous configuration of this embodiment involves the segments of the at least one pocket of the covering region at least at the upper side thereof having at least one rib-like reinforcement which extends in the conveying direction and in this instance obliquely relative to the center of the transverse extent of the covering region. The cooling air which is discharged from the cooling air channels between the dual-angled segments in or substantially in the conveying direction is consequently partially redirected via the reinforcements to the center of the covering region at the upper side of the grate plate, wherein the center of the upper plate side is provided by means of the center axis thereof which extends in the conveying direction. As a result of the pile geometry which is produced in a phased manner in this instance, there may be an increased cooling requirement in the central plate region. In particular, however, as already described above, the central region of the covering region in typical embodiments is pocket-free in order to enable securing of the plate with the lower side thereof to the grate cooler. Consequently, this central region does not have its own cooling arrangement, which is compensated for by the redirection of the cooling air on the reinforcements. The reinforcements which are typically produced as build-up welds, are in this instance produced from material which is particularly wear-resistant since, as a result of their exposed position, they are subjected to great abrasive and temperature-related effects of wear.

Another additional advantageous embodiment is produced in that the segments of the at least one pocket of the covering region each have at least one air guiding rib which, beginning in the base region of the grate plate and extending over the respective segment, directs cooling air as far as the upper side of the segment. Cooling air is thereby additionally directed in regions of the upper side of the dual-angled segment which, as a result of the autogenous wear protection layer which has been formed and the cooling air redirection which has been produced therewith, in particular in an upward direction, are otherwise subjected to only a potentially inadequate cooling. An arrangement of the air guiding ribs which extends obliquely inward produces the advantages produced in the embodiment described above as a result of the reinforcements of an increased cooling of the central region of the covering region by means of partial redirection of the cooling air flow from the gap-like cooling air channels between the segments.

In an advantageous embodiment of the invention, there is provision, with the pockets in the non-covering region, for the at least one opening which leads to the lower side of the grate plate to be arranged for the introduction of cooling air in such a manner that, when the grate plate is used in a grate cooler, the opening direction has an angle with respect to the vertical. If the opening for the cooling air supply is produced, for example, as a cylindrical channel, the longitudinal axis of these pipes is not positioned in a perpendicular manner, but instead forms an acute angle with respect to the vertical direction. This applies similarly in the case of differently but appropriately formed openings, as long as in this instance at least the opening region of the opening located in the direction toward the pocket base can be approximated by a cylinder so that the deviation from the vertical relates to the axis thereof. The opening mouth which decreases in projection relative to the vertical and the angled opening path result in larger particles of the hot bulk material, for example, larger cement clinker granules, solidifying more readily and quickly in the cooling air supply channel after start-up and then advantageously forming a barrier for afterflow of bulk material, whereby the material falling through the grate is reduced.

When grate plates are used in a grate cooler in a generic manner, the bulk material is conveyed by pushing by means of the end face of the moving grate plates in the conveying direction in the manner of a conveying edge. The grate plates therefore have at the front end face thereof a pushing edge. With the grate plates which are not moving, this performs the function of a counter-face with possible movements of the bulk material against the conveying direction during the alternating movement cycle of the moving grate plate rows. In a preferred embodiment of the invention, the grate plate has in an economically advantageous manner a replaceable pushing edge since the pushing edge is subjected to particularly significant wear. As a result of the expansion of the pushing edge in a vertical direction perpendicular to the conveying direction, the size of the gap with respect to the next grate plate in the conveying direction is adjusted.

### BRIEF DESCRIPTION OF THE DRAWINGS

The invention is explained in greater detail with reference to the following

Figures. In the drawings:

FIG. 1 is a perspective view of the grate plate according to the invention,

FIG. 2a is a plan view of the grate plate with a plane of section indicated,

FIG. 2b shows the grate plate from FIG. 2a in cross-section along this plane of section,

FIG. 3a is a plan view of the grate plate with an additional plane of section,

FIG. 3b shows the grate plate from FIG. 3a in cross-section along this additional plane of section, in particular with a section through the segments,

FIG. 4 is a perspective view of two grate plates which operate one above the other, and

FIG. 5 is a schematic section through two grate plate portions which are arranged one above the other with reinforcements.

### DETAILED DESCRIPTION OF THE PREFERRED EMBODIMENTS

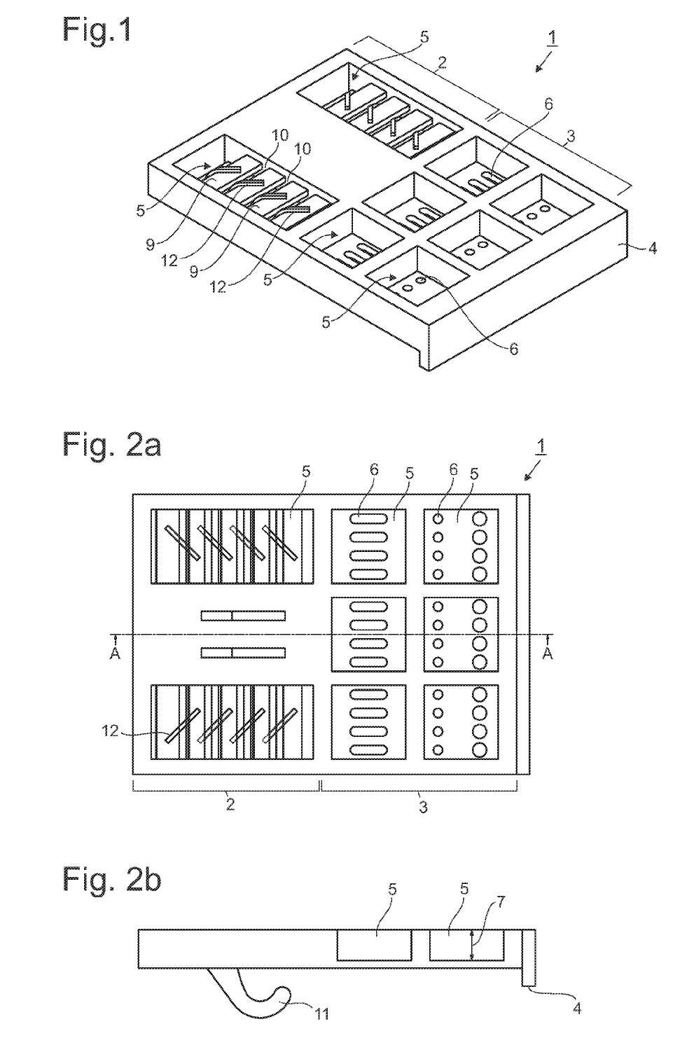

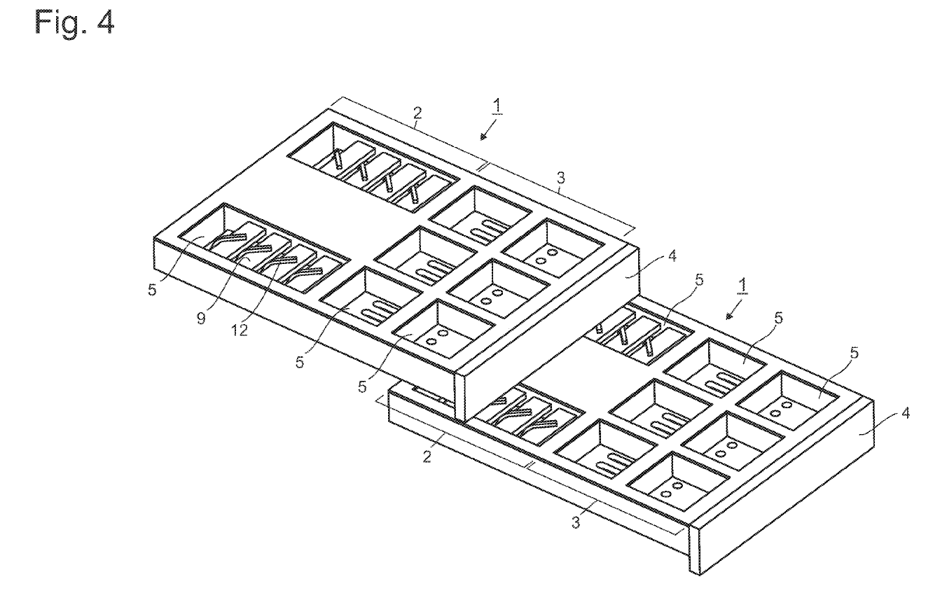

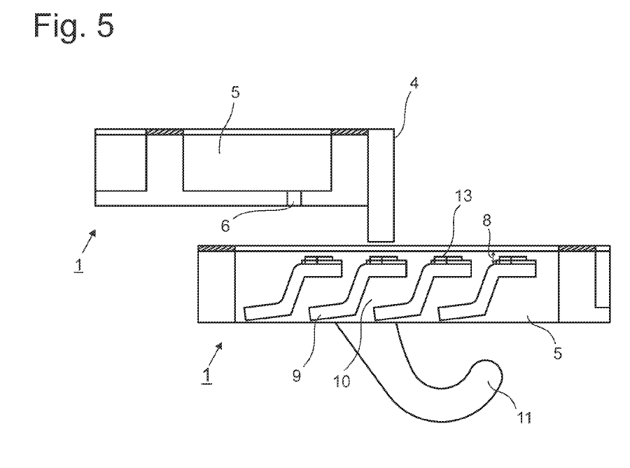

FIG. 1 illustrates a grate plate 1 according to the invention whose upper side is composed of a first operating region, the covering region 2 and a second operating region, the non-covering region 3. When this grate plate 1 is used in a grate cooler, hot bulk material (not illustrated) falls from the grate plate step located thereabove onto the covering region 2 and is pushed from that location by the oscillating back and forth movement of the grate plate(s) 1 above into the non-covering region 3. The interaction of two such grate plates 1 which are arranged in a stepped manner is illustrated in FIG. 4 (and in FIG. 5). On sequential steps, rows of grate plates 1 which are movably supported alternate with statically fixed rows of grate plates 1. For example, in the illustrations, the upper grate plate 1 can be assumed to be movable and carrying out oscillating pushing movements, whilst the lower grate plate 1 is fixed. In this manner, bulk material (not illustrated) which has fallen from the upper grate plate 1 into the covering region 2 of the lower grate plate 1 is pushed by the pushing edge 4 of the upper grate plate 1 into the non-covering region 3 of the lower grate plate 1 and during the next pushing cycle is conveyed by means of subsequent bulk material from the lower grate plate 1 via the pushing edge 4 thereof. In all the illustrations, the conveying direction is thus directed (with the exception of perspective rotations) from left to right. Therefore, the pushing edge 4 of the upper grate plate 1 in each case overlaps in a maximum advance position precisely the entire covering region 2 of the grate plate 1 located therebelow, but does not reach the non-covering region 3.

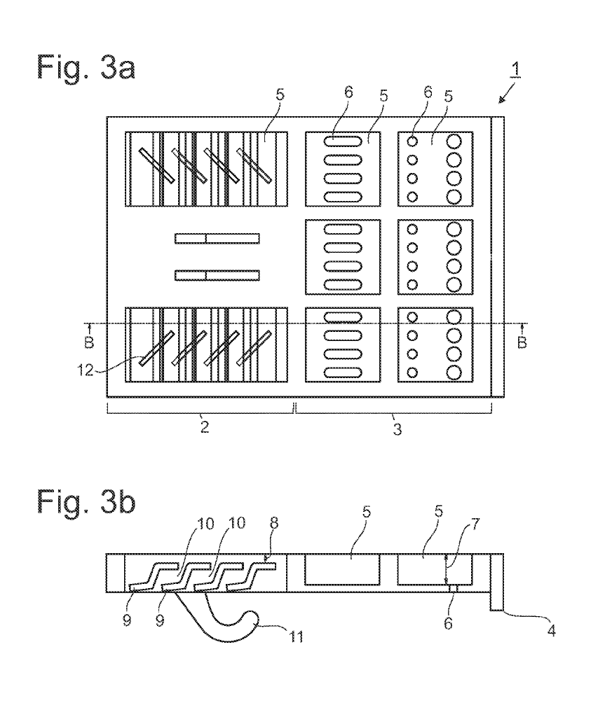

The grate plate 1 has in the non-covering region 3 pockets 5 which are preferably arranged, as in the embodiment illustrated, in rows and transversely relative to the conveying direction. In these pockets, during operation of the grate cooler there is retained bulk material which forms an autogenous wear protection layer (not illustrated) for the pockets 5 in the non-covering region 3. In contact with this layer, the bulk material bed is transported over the grate plate 1. In the base of the pockets 5 in the non-covering region 3, there are arranged openings 6 which lead to the lower side of the grate plate 1 and through which cooling air is blown into the wear protection layer and the conveyed material bed layer which is located thereon. The pockets 5 in the non-covering region 3 have a height which is just adequate for the formation of the wear protection layer, as drawn in FIG. 2b and in FIG. 3b. There are also arranged in the covering region 2 pockets 5 (see FIG. 1) which have such a height 8 (see FIG. 3b and FIG. 5) that during operation they also retain an autogenous wear protection layer (not illustrated).

According to the invention, the base of the pockets 5 in the covering region 2 is formed by the upper sides of a plurality of segments 9 in each case. These upper sides act as support faces for the wear protection layer of retained bulk material. Between the segments 9 of a pocket 5 which are arranged one behind the other in the illustrated embodiment, gap-like cooling air channels 10 for the supply of cooling air are formed. According to the invention, the height 8 of the pockets 5 is further in the covering region 2 significantly smaller (smaller than a third, preferably smaller than a fifth) of the height 7 of the pockets 5 in the non-covering region 3, as can also be seen in particular in FIG. 3b. Together with the feature according to the invention according to which the cooling air is blown out more in the conveying direction instead of vertically upward, in the borderline case even in the conveying direction out of the air cooling channel 10, and is blown into the bulk material, a particularly high compression of the wear protection layer in the covering region 2 is generally prevented and an effective and uniform cooling of the bulk material, for example, cement clinker from a rotary tubular kiln, is achieved in both operating regions 2 and 3 because overall it is unnecessary to compensate for any disadvantageously high pressure loss. At the same time, as has been found, an adequate wear protection is nevertheless also ensured in the pockets 5 in the covering region 2.

FIG. 2b shows the cross-section produced along the line of section A-A from FIG. 2a through the grate plate 1. In order to be able to secure the grate plate 1 in a non-positive-locking, but also releasable manner in the grate cooler, a hook 11 acting as a connection element is arranged in the central region of the lower side of the grate plate 1 below the covering region 2. For reasons of stability, there is no pocket above the hook 11, but instead a material face of adequate thickness.

The cross-section illustration in FIG. 3b, which is produced along the line of section B-B drawn in FIG. 3a shows, in particular, the preferred embodiment of segments 9 with a dual-angled profile. As a result of the slight cropping of a dual right-angled dual-angled profile in the conveying direction, blowing of the cooling air from the cooling air channels 10, that is to say, from the openings which are produced by them between the upper sides which as a result of the right-hand adjacent oblique-sided segment 9 deviate from the vertical at an angle, is promoted primarily in the conveying direction. An oblique positioning of the upper sides of the segments 9 and a resultant additional orientation of the upper opening mouths of the cooling air channels 10 at an additional angle with respect to the vertical could further promote this.

In the embodiment of the grate plates 1 according to the invention, in particular from FIG. 1 and FIG. 4, the dual-angled segments are provided with an additional air guiding rib 12 which directs cooling air far onto the upper side of the respective segment 9 and consequently further improves the cooling effect and wear protection. The additional air guiding ribs 2 direct as a result of the illustrated oblique positioning the cooling air from the cooling air channel 10 between the segments 9 in the direction toward the center of the covering region 2, where the grate plate 1 in the embodiment as a result of securing components 11 fitted therebelow does not have a pocket 5 and consequently also does not have a cooling or thermally insulating wear protection layer.

The effect of a redirection of cooling air to the center of the covering region is also achieved in embodiments with a correspondingly obliquely arranged rib-like reinforcement 13, for example, produced by means of a build-up welding 13, as illustrated in FIG. 5. In FIG. 5, there is further indicated not only an advantageous replaceability of the pushing edge 4 which is subjected to particular loads (at the upper of the two grate plates 1). Instead, it can also be seen that, as a result of the sizing of the pushing edge 4, the size of the gap with respect to the next grate plate is determined.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-10. (canceled)

11. A grate plate for use in a grate cooler for hot bulk material comprising:
a first operating region, referred to as a covering region, which is alternately covered by at least one additional grate plate when the grate plate is used in a grate cooler,
wherein the covering region has at least one pocket for retaining bulk material as an autogenous wear protection layer, and
a second operating region, referred to as a non-covering region, which is not covered by an additional grate plate when the grate plate is used in a grate cooler,
wherein the non-covering region for retaining bulk material as an autogenous wear protection layer has at least one pocket having at least one opening which leads to the lower side of the grate plate for the introduction of cooling air,
wherein a height of the at least one pocket in the covering region is smaller than a height of the at least one pocket in the non-covering region, and
wherein a base of the at least one pocket in the covering region is formed by a plurality of segments whose upper sides act as a support face for bulk material and between which gap-like cooling air channels are formed for supplying cooling air,
wherein, when the grate plate is used in a grate cooler, openings of the cooling air channels which are produced between the upper sides of the segments are each orientated at such an angle with respect to vertical that there is an acute angle in each case between a conveying direction of the bulk material and a direction of the cooling air flow through the openings.

12. The grate plate as claimed in claim 11, wherein the pockets in the covering region have the same height with respect to each other, the pockets in the non-covering region have the same height with respect to each other, and the height of the at least one pocket in the covering region is smaller than a third of the height of the at least one pocket in the non-covering region.

13. The grate plate as claimed in claim 12, wherein the height of the at least one pocket in the covering region is smaller than a fifth of the height of the at least one pocket in the non-covering region.

14. The grate plate as claimed in claim 11, wherein the openings of the cooling air channels produced between the upper sides of the segments in the covering region are orientated in such a manner that, when the grate plate is used in a grate cooler, the cooling air flow is introduced substantially in the conveying direction of the bulk material.

15. The grate plate as claimed in claim 11, wherein the at least one pocket in the covering region the segments which form the base are arranged one behind the other with respect to the conveying direction.

16. The grate plate as claimed in claim 11, wherein the segments of the at least one pocket in the covering region have in vertical cross-section parallel with the conveying direction a substantially dual-angled profile.

17. The grate plate as claimed in claim 16, wherein the segments of the at least one pocket of the covering region have at the upper side thereof at least one rib-like reinforcement which extends in the conveying direction and in this instance obliquely relative to the center of the transverse extent of the covering region.

18. The grate plate as claimed in claim 16, wherein the segments of the at least one pocket of the covering region each have at least one air guiding rib which beginning in the base region of the grate plate and extending over the respective segment directs cooling air as far as the upper side of the segment.

19. The grate plate as claimed in claim 11, wherein in the non-covering region the at least one opening which leads to the lower side of the grate plate for the introduction of cooling air is arranged in such a manner that, when the grate plate is used in a grate cooler the opening direction has an angle with respect to vertical.

20. The grate plate as claimed in claim 11, wherein the grate plate has a replaceable pushing edge.

21. The grate plate as claimed in claim 11, wherein at the lower side of the grate plate below the covering region a connection element is provided for securing the grate plate in a grate cooler.

22. The grate plate as claimed in claim 21, wherein the connection element comprises a hook device.
